(19) United States
(12) Patent Application Publication
(10) Pub. No.: US 2026/0036286 A1
(43) Pub. Date: Feb. 5, 2026

(54) REMOVABLE LIGHT ASSEMBLY FOR CONVERTIBLE GARAGE DOOR OPENER

(71) Applicant: ASSA ABLOY Entrance Systems AB, Landskrona (SE)

(72) Inventors: Davide Braggion, Cassano d'Adda (IT); Edoardo Umberto Penato, Cislago (IT); Vickie Lents, Winston-Salem, NC (US); David P. Bresson, Pfafftown, NC (US)

(21) Appl. No.: 18/795,093

(22) Filed: Aug. 5, 2024

(51) Int. Cl. F21V 21/08; F21V 17/10; F21V 23/04; F21V 23/06; F21V 33/00

(52) U.S. Cl. CPC F21V 21/08; F21V 17/104; F21V 23/0435; F21V 23/06; F21V 33/006

(57) ABSTRACT

A light assembly for use with a garage door operator (GDO) convertible between a ceiling mounted configuration and a jackshaft configuration may be provided. The light assembly may include a first illumination member and local and remote light housings to which the first illumination member may be independently removably operably coupleable. The first illumination member may be operable between an illuminated state in which it may illuminate an area and a non-illuminated state in which it may not illuminate the area. The local light housing may have a first power source and may be disposed at a main housing of a motorhead of the GDO. The remote light housing may have a second power source and may be disposed away from the main housing. The first illumination member may be operably coupled to one of the local light housing and the remote light housing at a time.

### TECHNICAL FIELD

Example embodiments generally relate to garage door operators (GDOs) and, in particular, relate to a light assembly for a GDO that is convertible between a jackshaft configuration and a ceiling mounted configuration.

### BACKGROUND

There have long been multiple solutions for providing residential GDOs. One such solution is for ceiling mounted GDOs that have a ceiling mounted linear force operator that drags one of the connected sections of the sectional door through the guides the door rides in between open and closed positions. Another solution, referred to as a jackshaft GDO, is a rotary torque operator mounted on the drive tube or shaft that rotates drums at opposing ends thereof. The drums coil and uncoil cables connected to the sectional door to pass the door through the guides between open and closed positions. Until recently, these two solutions have been provided in two relatively distinct channels with customers choosing products in one category for jackshaft GDOs and products from another category for ceiling mounted GDOs.

More recently, thought has been given to providing a single product that can be installed in either configuration (e.g., ceiling mounted or jackshaft). Thus, for example, the product may be installed as a ceiling mounted GDO (in what is sometimes called a trolley configuration), and then converted to be reinstalled in the jackshaft configuration, if desired. However, even this conversion technique may come with certain problems. One such problem comes in relation to the arrangement of a light on the GDO.

As an example, it is common for GDOs in the trolley configuration to have a built-in light that may illuminate the garage below the GDO either on command or when the GDO is activated to open and close the door. Due to the trolley configuration being mounted on the ceiling, the built-in light may be pointed towards the garage floor to illuminate the space evenly and effectively. Since the jackshaft configuration may be mounted on the drive tube or shaft, a built-in light on the GDO in the jackshaft configuration may be pointed in another direction besides towards the floor, and may therefore not illuminate the space as evenly and effectively as the built-in light on the trolley configuration.

Thus, for example, in the case of GDO's convertible between ceiling mounted configurations and jackshaft configurations, it may be preferable to provide a light assembly that may be detachable from, and disposed remotely relative to, the GDO to enable the user to configure the light assembly in the most effective manner for the space and for the needs/desires of the user.

### BRIEF SUMMARY OF SOME EXAMPLES

In an example embodiment, a light assembly for use with a garage door operator (GDO) convertible between a ceiling mounted configuration and a jackshaft configuration may be provided. The light assembly may include a first illumination member, a local light housing to which the first illumination member may be independently removably operably coupleable, and a remote light housing to which the first illumination member may also be independently removably operably coupleable. The first illumination member may be operable between an illuminated state in which the first illumination member may illuminate an area and a non-illuminated state in which the first illumination member may not illuminate the area. The local light housing may have a first power source and may be disposed at a main housing of a motorhead of the GDO. The remote light housing may have a second power source and may be disposed away from the main housing. The first illumination member may be operably coupled to one of the local light housing and the remote light housing at a time.

In another example embodiment, garage door operator (GDO) system may be provided. The GDO system may include a sectional door movable on rails between an open position and a closed position, a motorhead operable to provide power for movement of the sectional door between the open and closed positions via turning of a drive tube in a jackshaft configuration or via movement of a trolley in a ceiling mounted configuration, and a light assembly for use with the GDO convertible between the ceiling mounted configuration and the jackshaft configuration. The light assembly may include a first illumination member, a local light housing to which the first illumination member may be independently removably operably coupleable, and a remote light housing to which the first illumination member may also be independently removably operably coupleable. The first illumination member may be operable between an illuminated state in which the first illumination member may illuminate an area and a non-illuminated state in which the first illumination member may not illuminate the area. The local light housing may have a first power source and may be disposed at a main housing of a motorhead of the GDO. The remote light housing may have a second power source and may be disposed away from the main housing. The first illumination member may be operably coupled to one of the local light housing and the remote light housing at a time.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a perspective view of a GDO system in a ceiling mounted or trolley in accordance with an example embodiment;

FIG. 2 illustrates a perspective view of the GDO system in a jackshaft configuration in accordance with an example embodiment;

FIG. 3 illustrates a schematic block diagram of a light assembly for the GDO in accordance with an example embodiment;

FIG. 4 illustrates a perspective view of the light assembly according to an example embodiment;

FIG. 5 shows a perspective view of a remote light housing of the light assembly according to an example embodiment;

FIG. 6 illustrates a close up perspective view of the remote light housing of the light assembly in accordance with an example embodiment;

FIG. 7 illustrates a rear perspective view of the remote light housing of the light assembly according to an example embodiment;

FIG. 8 illustrates a rear perspective view of a first illumination member of the light assembly according to an example embodiment;

FIG. 9 illustrates a perspective view of the first illumination member operably coupling to the remote light housing of the light assembly according to an example embodiment;

FIG. 10 illustrates a perspective view of the first illumination member operably coupled to the remote light housing of the light assembly according to an example embodiment;

FIG. 11 illustrates a top view of a main housing of the motorhead including a local light housing of the light assembly according to an example embodiment;

FIG. 12 illustrates a perspective view of the main housing of the motorhead including the local light housing of the light assembly according to an example embodiment;

FIG. 13 illustrates a perspective view of the first illumination member operably coupling to the local light housing of the light assembly according to an example embodiment;

FIG. 14 illustrates a perspective view of the first illumination member operably coupled to the local light housing of the light assembly according to an example embodiment; and

FIG. 15 illustrates a schematic block diagram of the light assembly for the GDO in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, it may be desirable to provide a light assembly that may be detachable from the GDO and disposed remotely relative to the GDO. In some cases, the light assembly may include multiple light housings that may enable the user to move an illumination member between the light housings as desired depending on the configuration of the GDO. In an example embodiment, at least one of the light housings may be disposed at a motorhead of the GDO while at least one other of the light housings may be disposed remotely to the motorhead. In some cases, the light housings may be powered by separate power sources from each other and may be independently operable from each other as well. In an example embodiment, the light assembly may further include multiple illumination members as well.

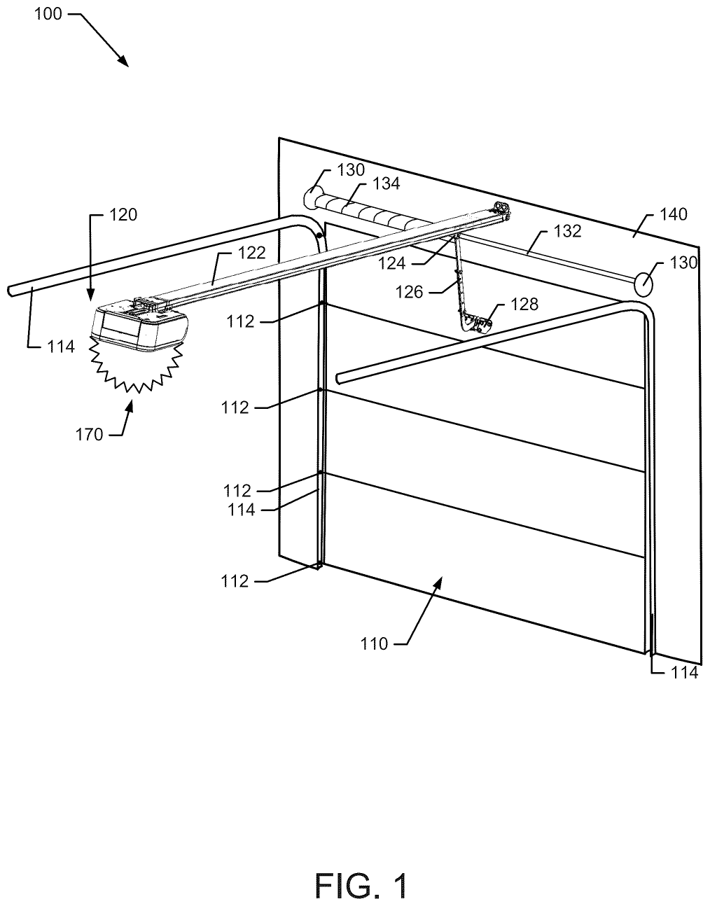

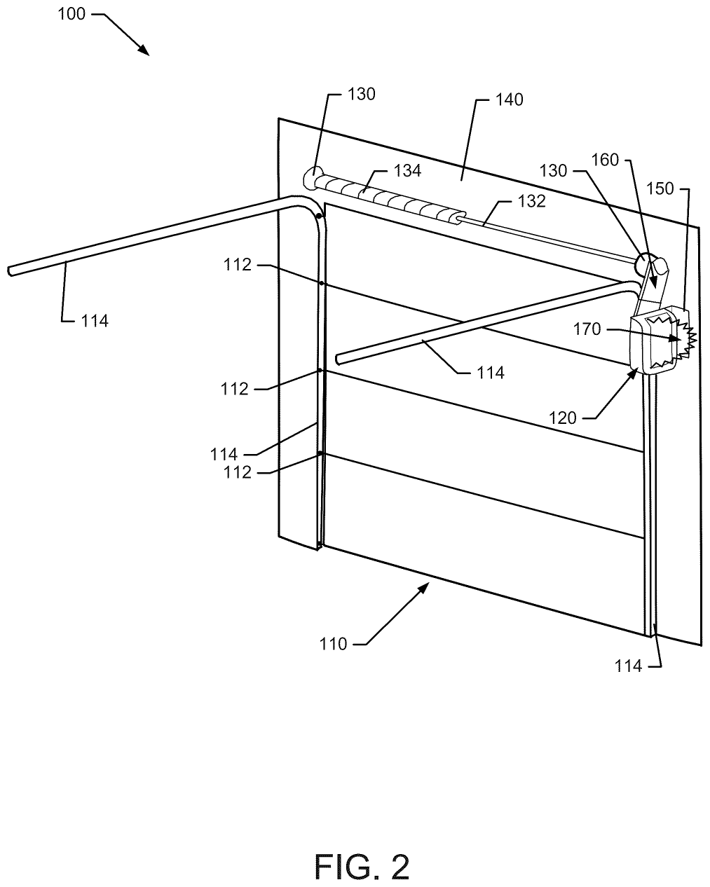

FIGS. 1 and 2 illustrate a GDO system 100 of an example embodiment. In this regard, FIG. 1 shows the GDO system 100 in a trolley configuration, and FIG. 2 shows the GDO system 100 in a jackshaft configuration. In both cases, the GDO system 100 includes a sectional door 110, in which each section of the door has wheels 112 operably coupled to opposing lateral sides of the sections. The wheels 112 ride in rails 114 disposed on opposing sides of the sectional door 110 as the sectional door 110 transitions between open and closed positions. The sectional door 110 of FIGS. 1 and 2 is shown in the closed position, where the wheels 112 are in a vertical section of the rails 114. Thus, it can be appreciated that in the open position the wheels 112 are located in a horizontally extending portion of the rails 114.

FIGS. 1 and 2 also illustrate a GDO unit referred to as opener 120. The opener 120 of this example may be converted from trolley configuration (shown in FIG. 1) to a jackshaft configuration (shown in FIG. 2). In the trolley configuration, a guide rail 122 may extend parallel to and approximately midway between the horizontally extending portion of the rails 114 on opposing lateral sides of the sectional door 110. The opener 120 may be mounted (e.g., from the ceiling) proximate to an end of the guide rail 122 to drive a trolley 124 along the guide rail 122 via a belt, cable or chain. The belt, cable or chain may also be operably coupled (e.g., via the trolley 124) to a top portion of the sectional door 110 by an engaging arm 126 and engaging bracket 128 that may be attached to the sectional door 110. As noted above, the trolley 124 may be manually released from the sectional door 110 to allow for manual repositioning of the sectional door 110.

In some cases, the sectional door 110 may also be supported by one or more instances of cables that are alternately wound onto and off of one or more cable drums 130 disposed at or near opposing ends of a tube 132. The tube 132 may further support a spring assembly 134 that facilitates, via the cables, supporting the weight of the sectional door 110 during opening and closing operations of the sectional door 110 using the opener 120. The sectional door 110, when closed, may block an opening provided in a front wall 140 of the garage in which the GDO system 100 may be installed. As can be seen in FIG. 1, the guide rail 122 may be secured to the front wall 140 at a proximal end of the guide rail 122, and the opener 120 may be suspended from the ceiling of the garage at a distal end of the guide rail 122.

The opener 120 of FIG. 1 (i.e., the exact same unit shown in FIG. 1) may be converted to a jackshaft configuration shown in FIG. 2 by mounting the opener 120 to the front wall 140. The opener 120 may also be mounted proximate to one of the rails 114 (or proximate to one of the drums 130) via a mounting bracket 150, on either side of the sectional door 110. In FIG. 2, the opener 120 is mounted on the right side (from the perspective of a viewer in the garage looking toward the sectional door 110) of the sectional door 110. However, the opener 120 could alternatively be installed on the left side of the sectional door 110. In either case, the opener 120 may be operably coupled to the tube 132 (now acting as a drive tube) via a transmission assembly 160. The opener 120 may then turn the tube 132 and thereby also turn the drum 130 disposed at an end of the tube 132 closest to the opener 120. The drum 130 may coil and uncoil cable for operation to close and open the sectional door 110 responsive to turning initiated by the opener 120.

Also shown in FIGS. 1 and 2, the opener 120 (which may also be referred to as a motorhead) may also include a light assembly 170. In some cases, such as the ones depicted in FIGS. 1 and 2, the light assembly 170 may often be disposed at a main housing 180 of the opener 120. When the opener 120 is configured in the ceiling mounted arrangement depicted in FIG. 1, the light assembly 170 being disposed at the main housing 180 may be optimal for most garages. In other words, the light assembly 170 may therefore be disposed at, or near, the ceiling and often central to the garage area, which may enable the light assembly 170 to illuminate the garage evenly and efficiently in many cases. However, with the opener 120 being convertible to a jackshaft configuration, the light assembly 170 disposed at the main housing 180 of the opener 120 may lose some of its practicality. In this regard, as shown in FIG. 2, when the opener 120 is configured in the jackshaft configuration, the motorhead may be disposed at or proximate to a wall, and often rotated relative to the ceiling mounted configuration. Thus, the light assembly 170 disposed at the main housing 180 of the opener 120 may end up being directed towards a wall, or otherwise away from the main garage area where illumination may be wanted/needed, responsive to converting the GDO from the ceiling mounted configuration of FIG. 1 to the jackshaft configuration of FIG. 2. As such, it may be desirable to design the light assembly 170 to be adaptable based on the configuration of the GDO and the desires of the user.

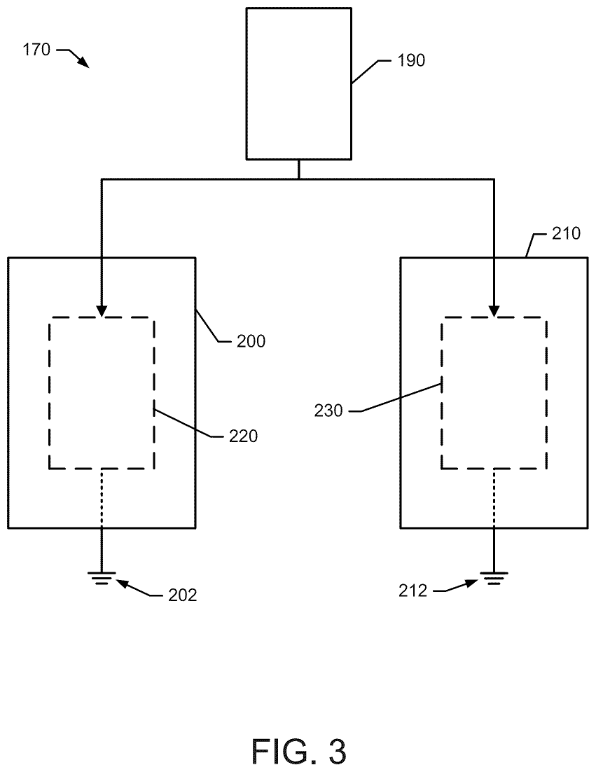

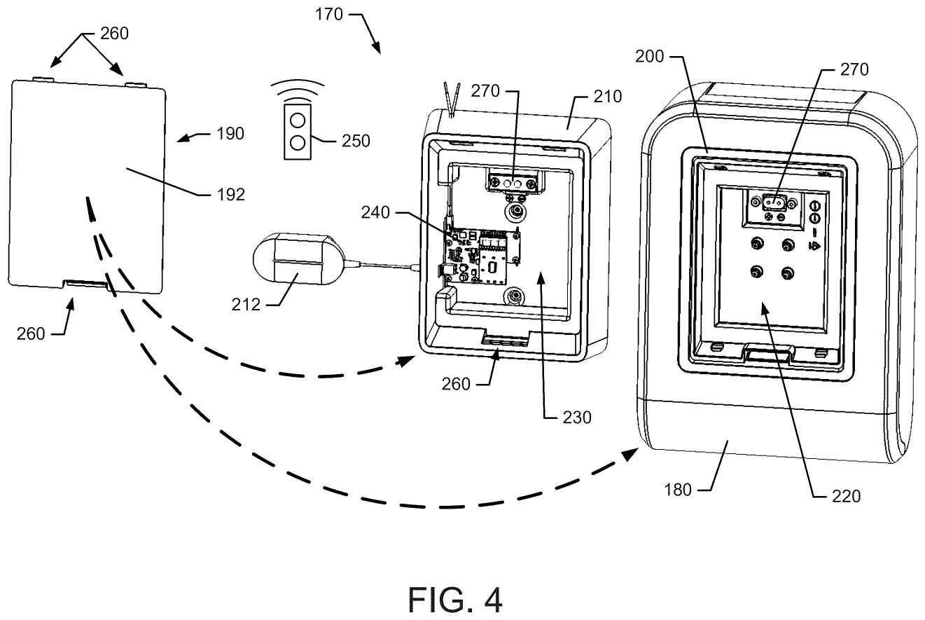

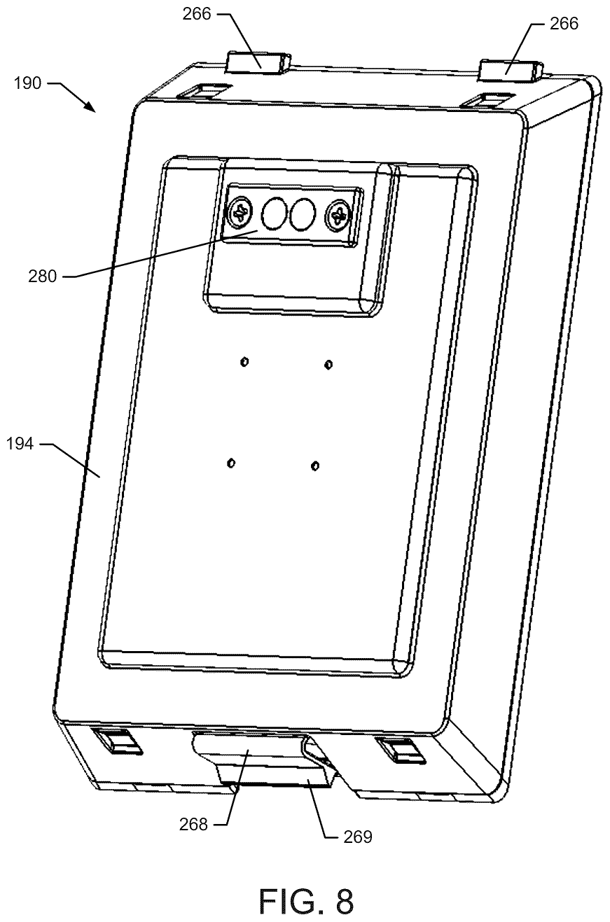

FIG. 3 depicts a schematic block diagram of the light assembly 170 according to an example embodiment, and FIG. 4 illustrates a perspective view of the light assembly 170 in accordance with an example embodiment. Referring now to FIGS. 3 and 4, the light assembly 170 of some example embodiments may include a first illumination member 190, a local light housing 200 and a remote light housing 210. The first illumination member 190 may be operable between an illuminated state in which the first illumination member 190 may illuminate an area and a non-illuminated state in which the first illumination member 190 does not illuminate the area. The first illumination member 190 may only be operable between the illuminated and non-illuminated states while the first illumination member 190 may be operably coupled to one of the local light housing 200 or the remote light housing 210. In other words, when the first illumination member 190 is not operably coupled to either of the local light housing 200 or the remote light housing 210, then the first illumination member 190 may remain in the non-illuminated state. In some cases, the first illumination member 190 may be embodied as a light emitting diode (LED), a panel of LEDs, an incandescent light bulb, a filament bulb, or any other similar type of light emitting object. In an example embodiment, the first illumination member 190 may include a casing having a cover 192 and a backing 194. The cover 192 may be entirely, or at least semi, translucent or transparent to allow light originating from within the casing to pass through the cover 192 to illuminate the space. In some cases, the backing 194 may operably couple to the cover 192 to define the casing. More details about the casing, including the backing 194 in particular, may be described below in reference to FIG. 8.

The first illumination member 190 may be independently removably operably coupleable to both of the local light housing 200 and the remote light housing 210. In this regard, the first illumination member 190 may be inserted into a first receiving cavity 220 formed in the local light housing 200 and into a second receiving cavity 230 formed in the remote light housing 210. In other words, the first illumination member 190 may only be inserted into one of the local light housing 200 and the remote light housing 210 at a time. Therefore, if the first illumination member 190 may be operably coupled to the local light housing 200 at the first receiving cavity 220, then it cannot be operably coupled to the remote light housing 210 at the second receiving cavity 230 simultaneously, and vice versa. In an example embodiment, such as the ones shown in FIGS. 1 and 2, the local light housing 200 may be disposed at the main housing 180 of the motorhead while the remote light housing 210 may be disposed away/separate from the main housing 180. In this regard, the local light housing 200 may be local to the main housing 180 of the motorhead, and the remote light housing 210 may be remote to the main housing 180 of the motorhead. In some cases, the local light housing 200 may be integrated with the main housing 180 of the motorhead. In this regard, the first illumination member 190 may effectively couple to the main housing 180 when disposed at the local light housing 200.

The local light housing 200 may be powered by a first power source 202 and the remote light housing 210 may be powered by a second power source 212. In some cases, the first and second power sources (202, 212) may be a source of electrical energy and may power the first illumination member 190. In some example embodiments, the first and second power sources (202, 212) may be different from each other. For example, the first power source 202 may be mains power and the second power source 212 may be a battery. In an example embodiment, the first power source 202 may be a same power source as the power source for the motorhead. For example, both the opener 120 motor and the local light housing 200 may be powered by mains power. In some other cases, the first and second power sources (202, 212) may be the same as each other (e.g. both mains power or both battery powered).

As can be appreciated from FIG. 4, the first and second receiving cavities (220, 230) may be similar to each other to enable the first illumination member 190 to be completely interchangeable between each of the local and remote light housings (200, 210). In this regard, in the first and second receiving cavities (220, 230), the local and remote light housings (200, 210) may each include respective instances of processing circuitry 240 which may be configured to control the alternation of the first illumination member 190 between the illuminated and non-illuminated states. In the embodiment shown in FIG. 4, the processing circuitry 240 in the remote light housing 210 may be disposed in the second receiving cavity 230 while the processing circuitry 240 in the local light housing 200 may be disposed behind the first receiving cavity 220, deeper within the main housing 180 (not shown in FIG. 4). The processing circuitry 240 may be configured to communicate with a remote actuator 250 to receive at least an actuation signal from the remote actuator 250 to control the alternation of the first illumination member 190 between the illuminated and non-illuminated states.

The processing circuitry 240 may be configured to provide electronic control inputs to one or more functional units of the light assembly 170 (and in a greater sense, the GDO) and to process data received at or generated by the one or more functional units of the light assembly 170. Thus, the processing circuitry 240 may be configured to perform data processing, control function execution and/or other processing and management services according to an example embodiment. In some embodiments, the processing circuitry 240 may be embodied as a chip or chip set. In other words, the processing circuitry 240 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 240 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 240 may include one or more instances of a processor and memory that may be in communication with or otherwise control other components or modules that interface with the processing circuitry 240. As such, the processing circuitry 240 may be embodied as a circuit chip (e.g., an integrated circuit chip) configured (e.g., with hardware, software or a combination of hardware and software) to perform operations described herein. In some embodiments, the processing circuitry 240 may be embodied as a portion of an onboard computer housed in both of the local light housing 200 and remote light housing 210 of the light assembly 170 to control operation of the assembly.

In some cases, the remote actuator 250 may be embodied as a remote control, a switch, a software interface on a computer, smartphone, smartwatch, vehicle, etc., or the like. In an example embodiment, the remote actuator 250 may communicate with the processing circuitry 240 via a wired connection. In some other cases, the remote actuator 250 may communicate with the processing circuitry 240 via wireless protocols, such as Bluetooth, Wi-Fi, infrared (IR), near-field communication (NFC), ZigBee, Z-wave, radio, or the like. In an example embodiment, the remote actuator 250 may simply control alternating the first illumination member 190 between the illuminated and non-illuminated states. In some other cases, the remote actuator 250 may retain these functionalities but may additionally control other settings related to the first illumination member 190 as well, such as a brightness setting (via a dimmer), a color setting, and more of the first illumination member 190.

As will be described in further detail below in reference to later figures, the first and second receiving cavities (220, 230) may be similar to each other in that they may each include respective features of a locking assembly 260. As such, the first illumination member 190 may include respective features of the locking assembly 260 that may engage the respective features of the locking assembly 260 at the first and second receiving cavities (220, 230) to securely and removably operably couple the first illumination member 190 to either of the local light housing 200 and the remote light housing 210 as desired.

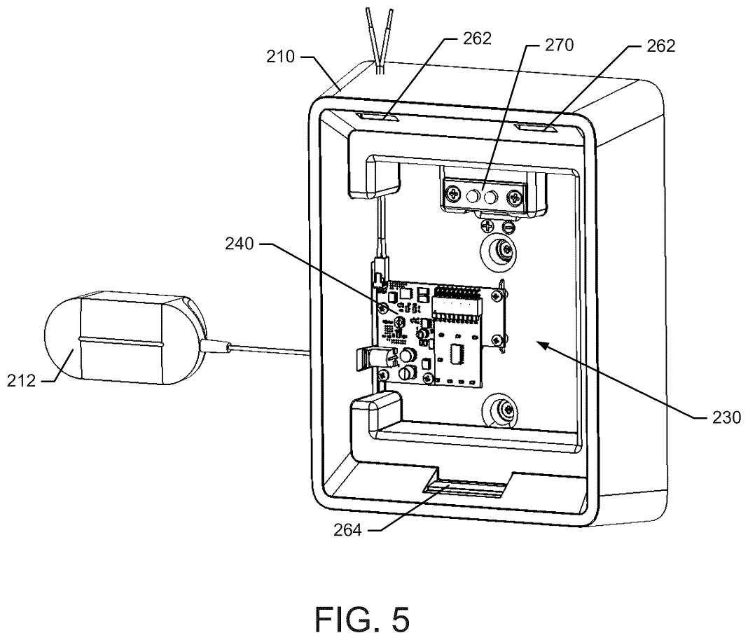

FIGS. 5-7 depict various views of the remote light housing 210 in accordance with an example embodiment. As shown in FIGS. 5, the remote light housing 210 may be a unitary member configured to operably couple to the first illumination member 190. In some cases, the remote light housing 210 may be configured to be disposed in a variety of possible positions, angles and orientations. Among the possible positions in which to mount the remote light housing 210 may be on a ceiling or a wall, to enable a user to optimally locate the remote light housing 210 relative to the local light housing 200 to better illuminate the area of the garage in which the GDO may be disposed. For example, when the opener 120 is in the jackshaft configuration, it may be advantageous for some users to mount the remote light housing 210 on the ceiling so that the area illuminated by the first illumination member 190 may be maximized as opposed to having the first illumination member 190 be disposed at the local light housing 200 where it may only illuminate a small section of the area. In other cases, the remote light housing 210 may be disposed at other locations besides the ceiling as well, including on an upright wall, on an angled wall, on a standalone mount, on the floor, etc., wherever the user may desire to maximize the effectiveness of the first illumination member 190.

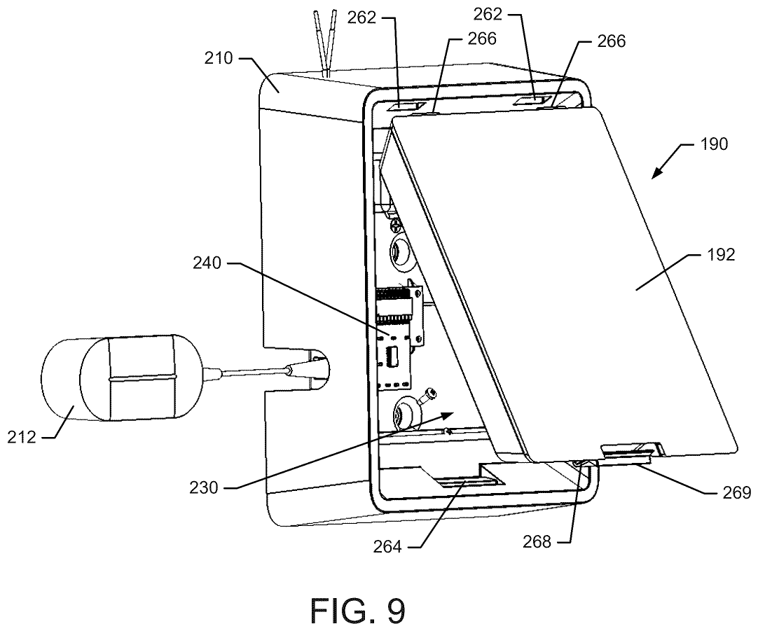

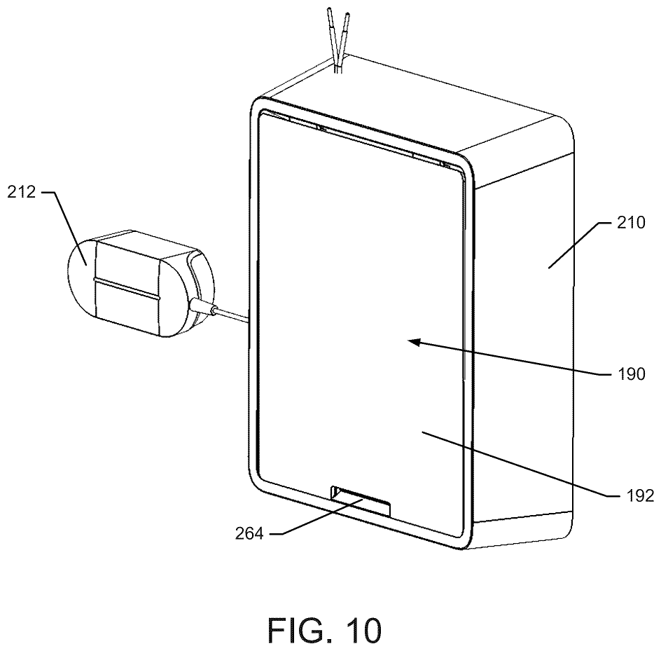

Regardless of the orientation in which the remote light housing 210 may be disposed, the locking assembly 260 may retain the first illumination member 190 securely operably coupled to the second receiving cavity 230. In this regard, the locking assembly 260 may include fixed retention features and at least one movable retention feature. In the example embodiment depicted in FIGS. 5-7, the remote light housing 210 may include receiving slots 262 and a locking tab 264 which may be examples of the fixed retention features. The receiving slots 262 may be formed in a peripheral portion of the second receiving cavity 230 proximate to where the first illumination member 190 may be received by the second receiving cavity 230. In this regard, the receiving slots 262 may engage with corresponding fixed retention features of the first illumination member 190 when operably coupling the first illumination member 190 to the second receiving cavity 230. As such, the receiving slots 262 may be cavities having a depth of at least a length of the corresponding fixed retention features of the first illumination member 190. The locking tab 264, may also be formed in a peripheral portion of the second receiving cavity 230 proximate to where the first illumination member 190 may be received by the second receiving cavity 230. However, the locking tab 264 may engage with the at least one movable retention feature of the first illumination member 190 when operably coupling the first illumination member 190 to the second receiving cavity 230. As such, the locking tab 264 may be a protrusion beyond which the at least one movable retention feature of the first illumination member 190 may extend responsive to being inserted into the second receiving cavity 230. The action of operably coupling the first illumination member 190 to the remote light housing 210 will be described in greater detail below in relation to FIGS. 9 and 10.

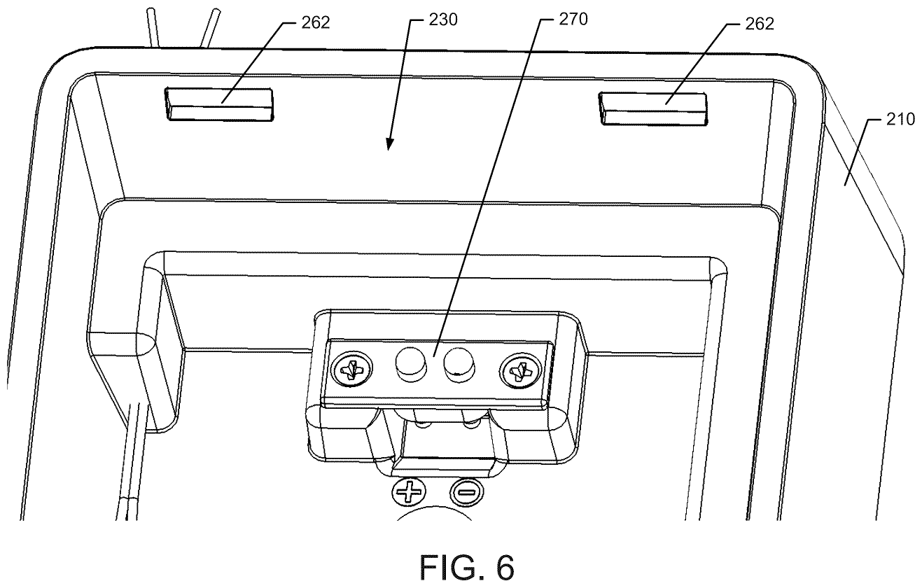

Also seen in FIGS. 5-7, the remote light housing 210 may further include a power outlet terminal 270 which may supply power to the first illumination member 190. The power outlet terminal 270 of some example embodiments may include at least a positive lead and a ground lead, and in some cases may include additional leads as needed. In an example embodiment, the power outlet terminal 270 may operably couple to the processing circuitry 240, and the processing circuitry 240 may control the flow of power from the second power source 212 to the first illumination member 190 via the power outlet terminal 270. When the processing circuitry 240 enables power to be provided to the first illumination member 190, the first illumination member 190 may enter the illuminated state. Conversely, when the processing circuitry 240 blocks power from being provided to the first illumination member 190, the first illumination member 190 may enter the non-illuminated state. The power outlet terminal 270 may be embodied in many different shapes and sizes and thus the shape and sizes of the power outlet terminal 270 depicted in FIGS. 5 and 6 should not be seen as limiting. The power outlet terminal 270 should, however, be shaped and sized to engage with a power inlet terminal 280 disposed on the first illumination member 190 as will be discussed below in reference to FIG. 8. The power inlet terminal 280 may be operably coupleable with the power outlet terminal 270 to transmit power from a respective one of the first and second power sources (202, 212) to the first illumination member 190.

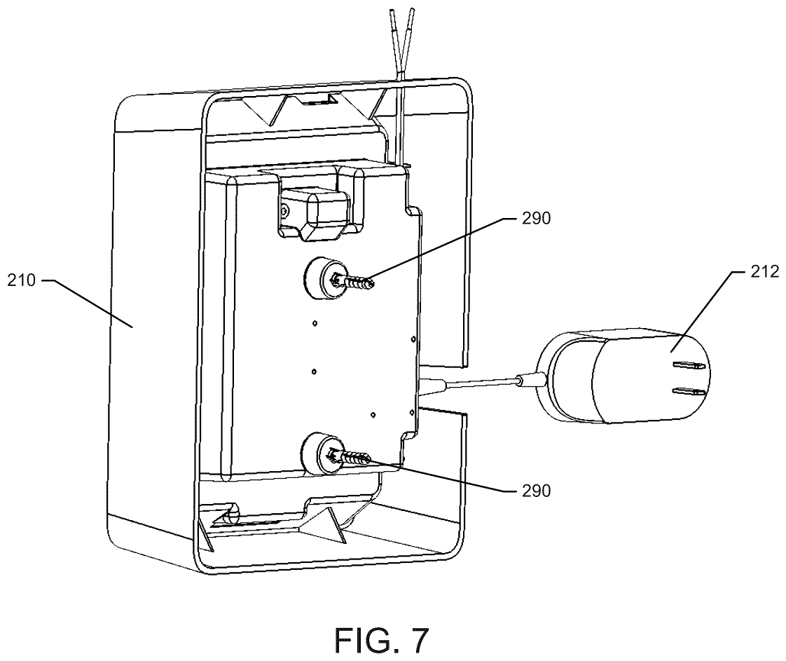

As seen in FIG. 7, the remote light housing 210 may include at least one fastener 290 to operably couple the remote light housing 210 to a desired mounting location. In this regard, the remote light housing 210 may be operably coupled to a wall, a ceiling or any other desired location in the garage area or not, via the at least one fastener 290. In some cases, the at least one fastener 290 may be a screw, a nail, an adhesive, a staple, a hook and loop fastener, or the like.

FIG. 8 illustrates a perspective view of the rear side of the first illumination member 190 according to an example embodiment. As mentioned above, the first illumination member 190 may include a cover 192 and a backing 194. The cover 192 may be operably coupled to the backing 194 to define the casing. In an example embodiment, the first illumination member 190 may include the power inlet terminal 280 disposed at the backing 194. As mentioned above, the power inlet terminal 280 may be located, shaped and sized to engage with the power outlet terminal 270 of the remote light housing 210 when operably coupled thereto. Thus, the power inlet terminal 280 may also include a positive lead and a ground lead to enable the transfer of electricity from the power outlet terminal 270 to the power inlet terminal 280.

Additionally, the backing 194 may include additional fixed retention features and the at least one movable retention feature of the locking assembly 260. In the example of FIG. 8, the backing 194 may include protruding tabs 266 disposed along a peripheral side of the backing 194 which may align with the receiving slots 262 when the first illumination member 190 may be operably coupled to the second receiving cavity 230. In this regard, the protruding tabs 266 may extend into, and engage with, the receiving slots 262 to secure at least one side of the first illumination member 190 to the remote light housing 210. In an example embodiment, the receiving slots 262 may be disposed at each of the local light housing 200 and the remote light housing 210 and the protruding tabs 266 may be disposed on the casing of the first illumination member 190. However, in some other cases, these fixed mounting features may be switched entirely, meaning the receiving slots 262 may be disposed on the casing of the first illumination member 190 and the protruding tabs 266 may be disposed at each of the local light housing 200 and the remote light housing 210. In some cases, they may be intermixed as well, meaning that some of the receiving slots 262 may be disposed on the first illumination member 190 and some at each of the local light housing 200 and the remote light housing 210 while some of the protruding tabs 266 may be disposed on the first illumination member 190 and some at each of the local light housing 200 and the remote light housing 210 as well.

The at least one movable retention feature may be a movable latch 268. The movable latch 268 may be substantially arcuate and in some cases, substantially C-shaped. In this regard, one side of the C-shaped movable latch 268 may be operably coupled to the backing 194 and thus fixed in place. The other side of the C-shaped movable latch 268 may be movable relative to the fixed side, and may be capable of being pinched or pushed towards the fixed side as desired. At the movable side of the movable latch 268, the movable latch 268 may also include a protuberance 269 which may engage the locking tab 264 to securely operably couple the first illumination member 190 to the second receiving cavity 230.

FIGS. 9 and 10 depict the process of operably coupling the first illumination member 190 to the remote light housing 210 in accordance with an example embodiment. The process may first include orienting the first illumination member 190 so that it may be substantially parallel to the remote light housing 210 and the cover 192 may be facing out and away from the remote light housing 210. Then, the first illumination member 190 may be angled slightly towards the protruding tabs 266 so that the protruding tabs 266 may be the first portion of the first illumination member 190 to enter the second receiving cavity 230. As such, the protruding tabs 266 may be inserted into their respective corresponding receiving slots 262, as shown in FIG. 9. Once the protruding tabs 266 have been inserted into the corresponding receiving slots 262, the movable latch 268 may be pushed towards the locking tab 264 until the protuberance 269 may be in contact with the locking tab 264. Then, with a little more force, the locking tab 264 may force the movable side of the movable latch 268 to move towards the fixed side via applying a force on the protuberance 269. Then, the protuberance 269 may move past the locking tab 264 and settle behind the locking tab 264 as the movable side of the movable latch 268 settles back into its normal position. Once this process is finished, the protuberance 269 may engage the locking tab 264 so that the movable latch 268 cannot be removed from the locking tab 264 without fist pinching the movable latch 268 to release the engagement of the protuberance 269 with the locking tab 264. The protuberance 269 passing by the locking tab 264 may sometimes emanate an audible click noise, which may indicate to the user that the first illumination member 190 may be securely operably coupled to the remote light housing 210, as shown in FIG. 10. To remove the first illumination member 190 from the remote light housing 210, the process may simply be followed in reverse to first release the movable latch 268 from the locking tab 264 followed by the protruding tabs 266 from their respective receiving slots 262.

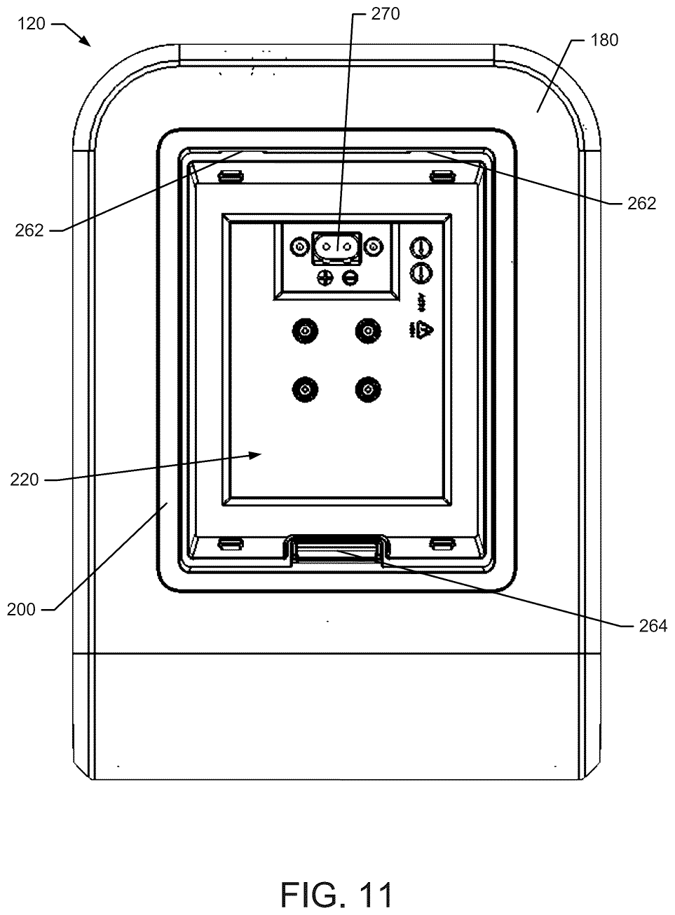

FIG. 11 illustrates the main housing 180 of the motorhead and the local light housing 200 in accordance with an example embodiment. Similar to the remote light housing 210 and the second receiving cavity 230, the local light housing 200 and the first receiving cavity 220 may be configured to retain the first illumination member 190 therein. In this regard, the local light housing 200 may also include the respective fixed retention features of the locking assembly 260 (i.e. the receiving slots 262 and the locking tab 264) and the power outlet terminal 270. Also, the first receiving cavity 220 may be substantially the same size and shape as the second receiving cavity 230, as well as having the same locking features as the second receiving cavity 230, to enable the first illumination member 190 to be interchangeable between the first and second receiving cavities (220, 230) at will. As can be seen from FIG. 11, in the local light housing 200, the first illumination member 190 may be limited to being directed in a direction away from the main housing 180. Since the motorhead may be convertible between a jackshaft configuration and a trolley configuration, the first illumination member 190 may therefore also be limited to a ceiling mounted position or a jackshaft mounted position when operably coupled to the local light housing 200. While a ceiling mounted configuration may be desirable for the light assembly 170, the jackshaft configuration may not be, hence why having the ability to interchange the first illumination member with the remote light housing 210 may be desirable to enable the user to have some flexibility with where the first illumination member 190 may be disposed.

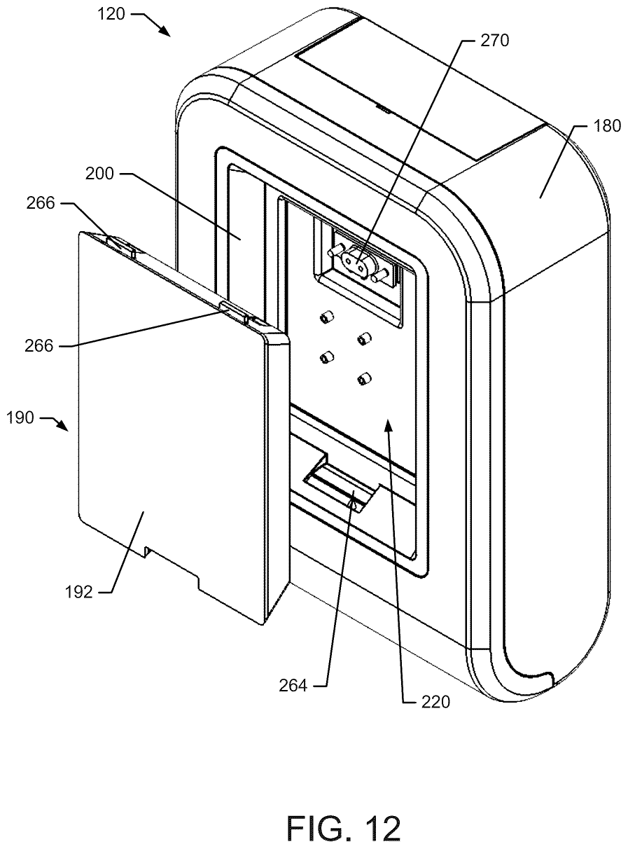

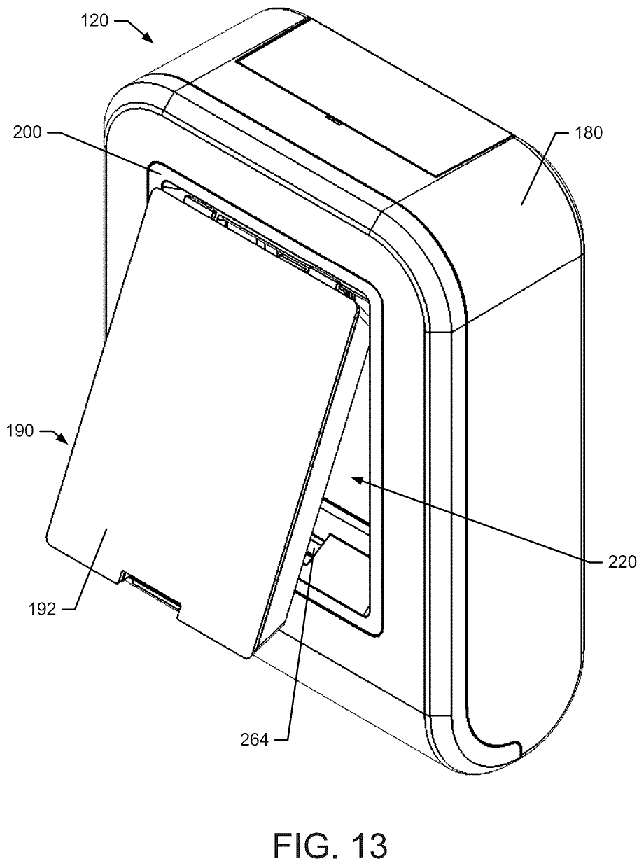

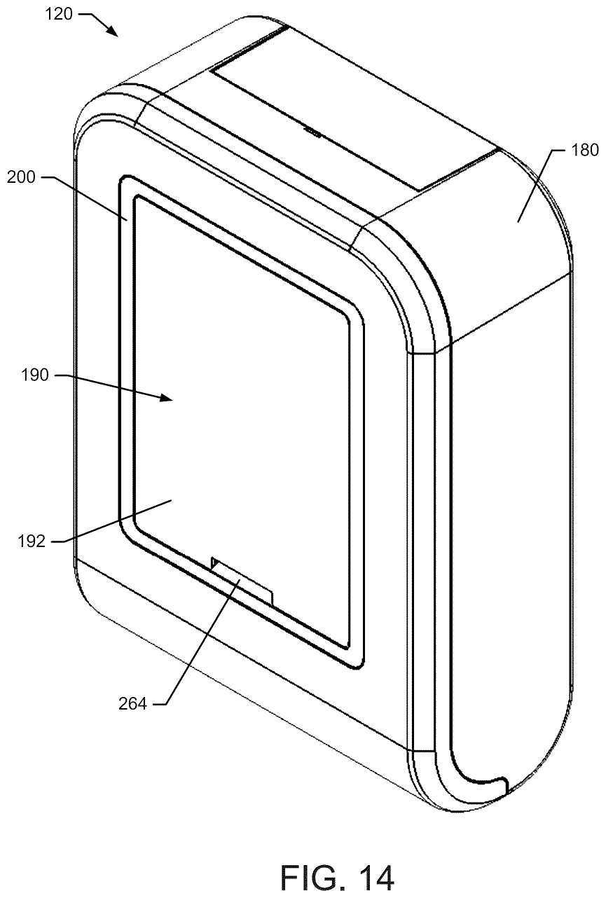

FIGS. 12-14 illustrate the process of inserting the first illumination member 190 into the local light housing 200 in accordance with an example embodiment. Similar to the process for inserting the first illumination member 190 into the remote light housing 210, the process may first include orienting the first illumination member 190 so that it may be substantially parallel to the local light housing 200 and so that the cover 192 may be facing out and away from the local light housing 200. Then, the first illumination member 190 may be angled slightly towards the protruding tabs 266 so that the protruding tabs 266 may be the first portion of the first illumination member 190 to enter the first receiving cavity 220. As such, the protruding tabs 266 may be inserted into their respective corresponding receiving slots 262, as shown in FIG. 13. Once the protruding tabs 266 have been inserted into the corresponding receiving slots 262, the movable latch 268 may be pushed towards the locking tab 264 until the protuberance 269 may be in contact with the locking tab 264. Then, with a little more force, the locking tab 264 may force the movable side of the movable latch 268 to move towards the fixed side via applying a force on the protuberance 269. Then, the protuberance 269 may move past the locking tab 264 and settle behind the locking tab 264 as the movable side of the movable latch 268 settles back into its normal position. Once this process is finished, the protuberance 269 may engage the locking tab 264 so that the movable latch 268 cannot be removed from the locking tab 264 without fist pinching the movable latch 268 to release the engagement of the protuberance 269 with the locking tab 264. The protuberance 269 passing by the locking tab 264 may sometimes emanate an audible click noise, which may indicate to the user that the first illumination member 190 may be securely operably coupled to the local light housing 200, as shown in FIG. 14. To remove the first illumination member 190 from the local light housing 200, the process may simply be followed in reverse to first release the movable latch 268 from the locking tab 264 followed by the protruding tabs 266 from their respective receiving slots 262.

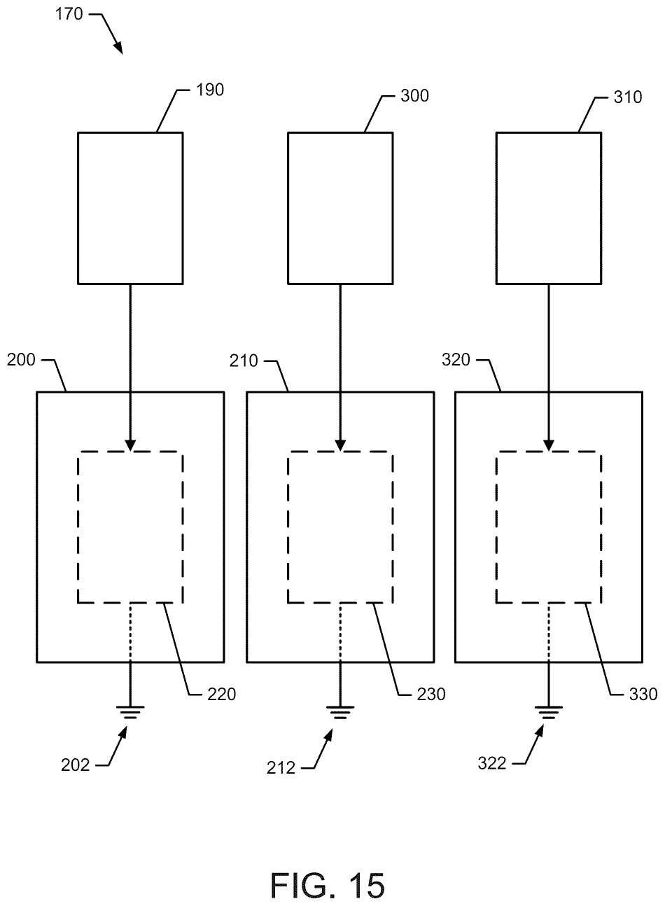

FIG. 15 illustrates a schematic block diagram of the light assembly 170 in accordance with an example embodiment. In the example embodiment depicted in FIG. 15, the light assembly 170 may further include a second illumination member 300, a third illumination member 310 and a second remote light housing 320. In other words, the light assembly 170 may be capable of adding a plurality of remote light housings and a plurality of illumination members, in some cases as many as may be desired by the user. In the example embodiment depicted herein, the first illumination member 190 may be operably coupled to the local light housing 200 while the second illumination member 300 may be operably coupled to the remote light housing 210 and the third illumination member 310 may be operably coupled to the second remote light housing 320. In some other cases, the illumination members may be interchangeable so any combination of illumination members with light housings may be achievable. In some cases, the second remote light housing 320 may be disposed away from the main housing 180 of the motorhead of the GDO as well. It should be appreciated that the light assembly 170 could be optioned with any number of remote light housings and illumination members as well. For instance, the light assembly 170 of some example embodiments may include the local light housing 200, the remote light housing 210, and perhaps one or more other remote light housings. Such cases may also include at least the first illumination member 190 so that the first illumination member 190 may be moved freely to any of the light housings as desired.

In the example embodiment of FIG. 15, the local light housing 200 may be powered by the first power source 202, the remote light housing 210 may be powered by the second power source 212 and the second remote light housing 320 may be powered by a third power source 322. In some cases, the first, second and third power sources (202, 212, 322) may be sources of electrical energy and may power a respective illumination member. In some example embodiments, the first, second and third power sources (202, 212, 322) may be different from each other. For example, the first power source 202 may be mains power, the second power source 212 may be a battery, and the third power source 322 may be a generator. In an example embodiment, the first power source 202 may be a same power source as the power source for the motorhead. For example, both the opener 120 motor and the local light housing 200 may be powered by mains power. In some other cases, the first, second and third power sources (202, 212, 322) may be the same as each other (e.g. all mains power or all battery powered).

It should also be appreciated that in the example embodiment of FIG. 15, the first receiving cavity 220, the second receiving cavity 230 and a third receiving cavity 330 may all be substantially the same to enable the first illumination member 190 (or any illumination member for that matter) to be freely interchangeable between light housings. In this regard, the first, second and third receiving cavities (220, 230, 330) may all include similar locking features, similar power outlet terminals, and similar shapes, sizes and locations of features to enable the interchangeability. In other words, the light assembly 170 of some cases may be modular.

Accordingly, some example embodiments may provide a light assembly for use with a garage door operator (GDO) convertible between a ceiling mounted configuration and a jackshaft configuration. The light assembly may include a first illumination member, a local light housing to which the first illumination member may be independently removably operably coupleable, and a remote light housing to which the first illumination member may also be independently removably operably coupleable. The first illumination member may be operable between an illuminated state in which the first illumination member may illuminate an area and a non-illuminated state in which the first illumination member may not illuminate the area. The local light housing may have a first power source and may be disposed at a main housing of a motorhead of the GDO. The remote light housing may have a second power source and may be disposed away from the main housing. The first illumination member may be operably coupled to one of the local light housing and the remote light housing at a time.

The light assembly for use with a garage door operator (GDO) convertible between a ceiling mounted configuration and a jackshaft configuration described above may be augmented or modified by altering individual features mentioned above or adding optional features. The augmentations or modifications may be performed in any combination and in any order. For example, in some cases, the remote light housing may be configured to be disposed in a variety of possible positions, angles and orientations, including on a ceiling, to enable a user to optimally locate the remote light housing relative to the local light housing. In an example embodiment, each of the local light housing and the remote light housing may include respective instances of processing circuitry which may alternate the first illumination member between the illuminated and non-illuminated states. In some cases, the light assembly may further include a remote actuator. In an example embodiment, the remote actuator may communicate with at least one of the respective instances of processing circuitry to alternate the first illumination member between the illuminated and non-illuminated states. In some cases, the remote actuator may communicate with the at least one of the respective instances of processing circuitry via Bluetooth. In an example embodiment, the light assembly may further include a second illumination member. In some cases, the first illumination member may be operably coupled to the local light housing while the second illumination member may be operably coupled to the remote light housing. In an example embodiment, the light assembly may further include a third illumination member operably coupled to a second remote light housing. In some cases, the second remote light housing may be disposed away from the main housing of the motorhead of the GDO. In an example embodiment, each of the local light housing and the remote light housing may include a power outlet terminal. In some cases, the first illumination member may include a power inlet terminal, the power inlet terminal may be operably coupleable with the power outlet terminal to transmit power from a respective one of the first and second power sources to the first illumination member. In an example embodiment, the light assembly may further include a locking assembly which may securely operably couple the first illumination member to the local light housing and the remote light housing, the locking assembly may include fixed retention features and at least one movable retention feature. In some cases, the fixed retention features may include protruding tabs and receiving slots, the protruding tabs may be disposed on the first illumination member and the receiving slots may be disposed at the local light housing and the remote light housing. In an example embodiment, the receiving slots may receive the protruding tabs therein when the first illumination member may be operably coupled to either of the local light housing and the remote light housing. In some cases, the first power source for the local light housing may also power the motorhead. In an example embodiment, the second power source for the remote light housing may only power the remote light housing.

Some additional example embodiments may provide a garage door operator (GDO) system. The GDO system may include a sectional door movable on rails between an open position and a closed position, a motorhead operable to provide power for movement of the sectional door between the open and closed positions via turning of a drive tube in a jackshaft configuration or via movement of a trolley in a ceiling mounted configuration, and a light assembly for use with the GDO convertible between the ceiling mounted configuration and the jackshaft configuration. The light assembly may include a first illumination member, a local light housing to which the first illumination member may be independently removably operably coupleable, and a remote light housing to which the first illumination member may also be independently removably operably coupleable. The first illumination member may be operable between an illuminated state in which the first illumination member may illuminate an area and a non-illuminated state in which the first illumination member may not illuminate the area. The local light housing may have a first power source and may be disposed at a main housing of a motorhead of the GDO. The remote light housing may have a second power source and may be disposed away from the main housing. The first illumination member may be operably coupled to one of the local light housing and the remote light housing at a time.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A light assembly for use with a garage door operator (GDO) convertible between a ceiling mounted configuration and a jackshaft configuration, the light assembly comprising:
a first illumination member, the first illumination member being operable between an illuminated state in which the first illumination member illuminates an area and a non-illuminated state in which the first illumination member does not illuminate the area;
a local light housing to which the first illumination member is independently removably operably coupleable, the local light housing having a first power source and being disposed at a main housing of a motorhead of the GDO; and
a remote light housing to which the first illumination member is independently removably operably coupleable, the remote light housing having a second power source and being disposed away from the main housing,
wherein the first illumination member is operably coupled to one of the local light housing and the remote light housing at a time.

2. The light assembly of claim 1, wherein the remote light housing is configured to be disposed in a variety of possible positions, angles and orientations, including on a ceiling, to enable a user to optimally locate the remote light housing relative to the local light housing.

3. The light assembly of claim 1, wherein each of the local light housing and the remote light housing comprises respective instances of processing circuitry configured to alternate the first illumination member between the illuminated and non-illuminated states.

4. The light assembly of claim 3, wherein the light assembly further comprises a remote actuator, and
wherein the remote actuator communicates with at least one of the respective instances of processing circuitry to alternate the first illumination member between the illuminated and non-illuminated states.

5. The light assembly of claim 4, wherein the remote actuator communicates with the at least one of the respective instances of processing circuitry via Bluetooth.

6. The light assembly of claim 1, wherein the light assembly further comprises a second illumination member, and
wherein the first illumination member is operably coupled to the local light housing while the second illumination member is operably coupled to the remote light housing.

7. The light assembly of claim 6, wherein the light assembly further comprises a third illumination member operably coupled to a second remote light housing, and
wherein the second remote light housing is disposed away from the main housing of the motorhead of the GDO.

8. The light assembly of claim 1, wherein each of the local light housing and the remote light housing comprises a power outlet terminal, and
wherein the first illumination member comprises a power inlet terminal, the power inlet terminal being operably coupleable with the power outlet terminal to transmit power from a respective one of the first and second power sources to the first illumination member.

9. The light assembly of claim 1, wherein the light assembly further comprises a locking assembly to securely operably couple the first illumination member to the local light housing and the remote light housing, the locking assembly comprising fixed retention features and at least one movable retention feature.

10. The light assembly of claim 9, wherein the fixed retention features comprise protruding tabs and receiving slots, the protruding tabs being disposed on the first illumination member and the receiving slots being disposed at the local light housing and the remote light housing,
wherein the receiving slots are configured to receive the protruding tabs therein when the first illumination member is operably coupled to either of the local light housing and the remote light housing.

11. The light assembly of claim 1, wherein the first power source for the local light housing also powers the motorhead, and
wherein the second power source for the remote light housing only powers the remote light housing.

12. A garage door operator (GDO) system comprising:
a sectional door movable on rails between an open position and a closed position;
a motorhead operable to provide power for movement of the sectional door between the open and closed positions via turning of a drive tube in a jackshaft configuration or via movement of a trolley in a ceiling mounted configuration; and
a light assembly for use with the GDO convertible between the ceiling mounted configuration and the jackshaft configuration, the light assembly comprising:
a first illumination member, the first illumination member being operable between an illuminated state in which the first illumination member illuminates an area and a non-illuminated state in which the first illumination member does not illuminate the area;
a local light housing to which the first illumination member is independently removably operably coupleable, the local light housing having a first power source and being disposed at a main housing of the motorhead; and
a remote light housing to which the first illumination member is independently removably operably coupleable, the remote light housing having a second power source and being disposed away from the main housing,
wherein the first illumination member is operably coupled to one of the local light housing and the remote light housing at a time.

13. The system of claim 12, wherein the remote light housing is configured to be disposed in a variety of possible positions, angles and orientations, including on a ceiling, to enable a user to optimally locate the remote light housing relative to the local light housing.

14. The system of claim 12, wherein each of the local light housing and the remote light housing comprises respective instances of processing circuitry configured to alternate the first illumination member between the illuminated and non-illuminated states.

15. The system of claim 14, wherein the light assembly further comprises a remote actuator,
wherein the remote actuator communicates with at least one of the respective instances of processing circuitry to alternate the first illumination member between the illuminated and non-illuminated states, and
wherein the remote actuator communicates with the at least one of the respective instances of processing circuitry via Bluetooth.

16. The system of claim 12, wherein the light assembly further comprises a second illumination member, and
wherein the first illumination member is operably coupled to the local light housing while the second illumination member is operably coupled to the remote light housing.

17. The system of claim 16, wherein the light assembly further comprises a third illumination member operably coupled to a second remote light housing, and
wherein the second remote light housing is disposed away from the main housing of the motorhead.

18. The system of claim 12, wherein each of the local light housing and the remote light housing comprises a power outlet terminal, and
wherein the first illumination member comprises a power inlet terminal, the power inlet terminal being operably coupleable with the power outlet terminal to transmit power from a respective one of the first and second power sources to the first illumination member.

19. The system of claim 12, wherein the light assembly further comprises a locking assembly to securely operably couple the first illumination member to the local light housing and the remote light housing, the locking assembly comprising fixed retention features and at least one movable retention feature,
wherein the fixed retention features comprise protruding tabs and receiving slots, the protruding tabs being disposed on the first illumination member and the receiving slots being disposed at the local light housing and the remote light housing, and
wherein the receiving slots are configured to receive the protruding tabs therein when the first illumination member is operably coupled to either of the local light housing and the remote light housing.

20. The system of claim 12, wherein the first power source for the local light housing also powers the motorhead, and
wherein the second power source for the remote light housing only powers the remote light housing.
